(19) United States
(12) Patent Application Publication
(10) Pub. No.: US 2015/0145804 A1
(43) Pub. Date: May 28, 2015

(54) TOUCH APPARATUS

(71) Applicant: HengHao Technology Co. LTD, Taoyuan County (TW)

(72) Inventor: KUAN-YEN MA, Taoyuan County (TW)

(73) Assignee: HengHao Technology Co. LTD, Taoyuan County (TW)

(21) Appl. No.: 14/102,066

(22) Filed: Dec. 10, 2013

(30) Foreign Application Priority Data
Nov. 26, 2013 (TW) 102142997

(51) Int. Cl. G06F 3/041; G06F 3/044

(52) U.S. Cl. CPC G06F 3/0412; G06F 3/044
USPC 345/174

(57) ABSTRACT

A touch apparatus includes at least one optically-clear adhesive (OCA) layer, a first electrode layer and a second electrode layer. The second electrode layer bonds with one of the at least one OCA layer, which acts both as a substrate and an adhesive.

### BACKGROUND OF THE INVENTION

1. Field of the Invention

The disclosure generally relates to a touch apparatus, and more particularly to a touch apparatus with an electrode layer bonded with an optically-clear adhesive (OCA) layer.

2. Description of Related Art

Touch screen input/output devices adopting sensing and display technologies have been widely accepted, and continue to be employed in electronic devices such as portable or hand-held electronic devices.

A capacitor-based touch panel as commonly used harnesses a capacitive coupling effect to detect touch position. Specifically, the change in capacitance corresponding to a given touch position is detected when a finger touches a surface of the touch panel.

The electrode layer of a conventional touch panel is manufactured by first forming indium tin oxide (ITO) on a transparent substrate (e.g., glass), followed by complex processes such as exposure, development and etching to obtain patterned electrodes. As the thickness of the transparent substrate cannot be effectively reduced, an overall thickness of the touch panel thus cannot be reduced in an effective manner.

For the foregoing reasons, a need has thus arisen to propose a novel touch apparatus for substantially overcoming disadvantages of the conventional touch panel.

### SUMMARY OF THE INVENTION

In view of the foregoing, it is an object of the embodiment of the present invention to provide a touch panel with an electrode layer bonded with an optically-clear adhesive (OCA) layer, thereby effectively reducing an overall thickness of the touch panel and simplifying associated processes.

According to one embodiment, a touch apparatus includes at least one optically-clear adhesive (OCA) layer, a first electrode layer, and a second electrode layer. The second electrode layer is bonded with one of the at least one OCA layer, the OCA layer bonded with the second electrode layer acting as a substrate and an adhesive.

### BRIEF DESCRIPTION OF THE DRAWINGS

FIG. 1 is a cross-sectional view of a touch apparatus according to a first embodiment of the present invention;

FIG. 2A and FIG. 2B are cross-sectional views of a touch apparatus according to a second embodiment of the present invention; and

FIG. 3A and FIG. 3B are cross-sectional views of a touch apparatus according to a third embodiment of the present invention.

### DETAILED DESCRIPTION OF THE INVENTION

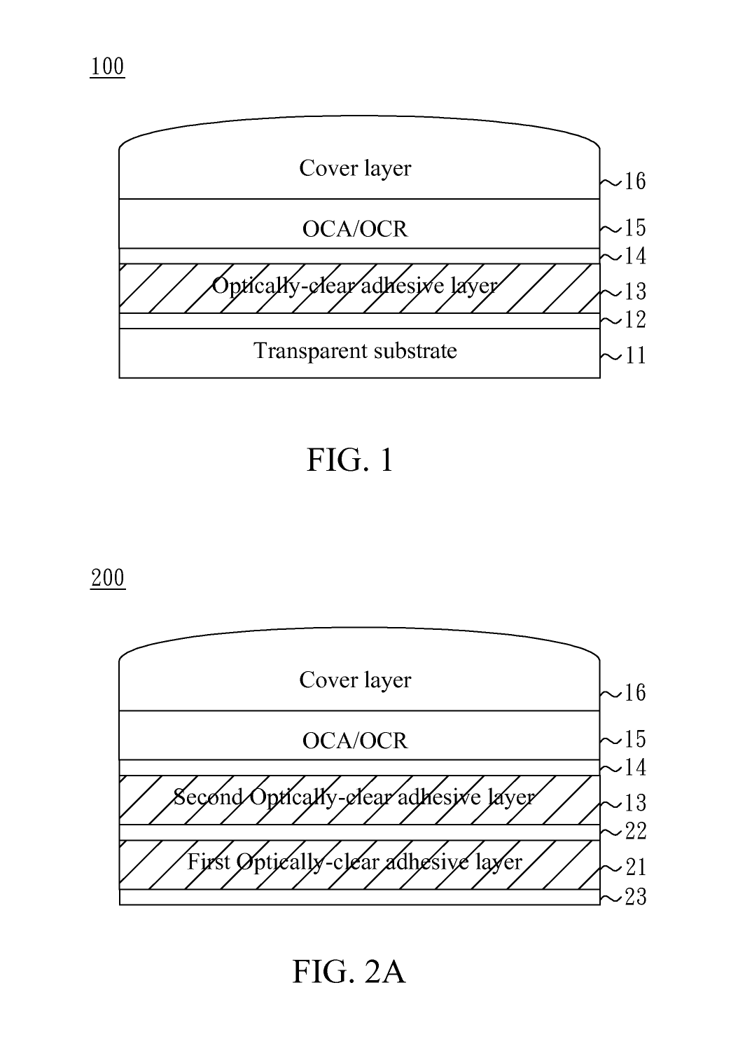

Referring more particularly to the drawings, FIG. 1 shows a cross-sectional view of a touch apparatus 100 according to a first embodiment of the present invention. In the embodiment, the touch apparatus 100 includes a transparent substrate 11, which may comprise insulating material such as, but not necessarily, glass, Polycarbonate (PC), Polyethylene terephthalate (PET), Polyethylene (PE), Poly vinyl chloride (PVC), Poly propylene (PP),

Poly styrene (PS), Polymethyl methacrylate (PMMA) or Cyclic olefin copolymer (COC).

A first electrode layer 12, such as a transmit electrode (commonly called Tx electrode), is formed on a top surface of the transparent substrate 11 using a conventional technique and is then patterned using a conventional technique. In the embodiment, the first electrode layer 12 may be made of transparent conductive material such as, but not necessarily, indium tin oxide (ITO), indium zinc oxide (IZO), Al-doped ZnO (AZO) or antimony tin oxide (ATO).

An optically-clear adhesive (OCA) layer 13 is formed above the first electrode layer 12. Then, a second electrode layer 14, such as a receive electrode (commonly called Rx electrode), is bonded with a top surface of the OCA layer 13. In the embodiment, the OCA layer 13 and the second electrode layer 14 compose a transparent conductive transfer film (TCTF), which may be directly bonded with the first electrode layer 12. The OCA layer 13 of the embodiment has a thickness greater than 50 micrometers. The second electrode layer 14 may comprise non-transparent conductive material such as metal nanowires (e.g., silver nanowires or copper nanowires) or metal nanonets (e.g., silver nanonets or copper nanonets). The metal nanowires or nanonets have diameters on the order of nanometers (i.e., a few nanometers to hundreds of nanometers), and may be fixed via a plastic material (e.g., resin). Due to their fineness the metal nanowires/nanonets are unobservable to human eyes, and the second electrode layer 14 made of the metal nanowires/nanonets thus has high light-transmittance. The second electrode layer 14 may further include a photosensitive material, through which electrodes with a required pattern may be directly formed via an exposure development process without using photoresist.

According to one aspect of the embodiment, the OCA layer 13 acts as a substrate (or a spacer) for the second electrode layer 14 to replace a conventional transparent substrate (e.g., glass or PET) and an adhesive. In other words, the OCA layer 13 of the embodiment exhibits at least functions of a substrate and an adhesive. Accordingly, compared with the architecture of a conventional touch panel, the touch apparatus 100 of the embodiment may be substantially reduced in overall thickness to facilitate thinning of the touch apparatus 100.

Above the second electrode layer 14 is an adhesive layer 15 that is bonded between the second electrode layer 14 and a cover layer 16. The adhesive layer 15 may comprise (solid) optically-clear adhesive (OCA) or (liquid) optically-clear resin (OCR). The cover layer 16 may be a two-dimensional cover layer with a planar surface, or a three-dimensional cover layer with a curved surface. The cover layer 16 may comprise flexible or rigid insulating material with high light-transmittance such as, but not necessarily, glass, Polycarbonate (PC), Polyethylene terephthalate (PET), Polymethyl methacrylate (PMMA) or Cyclic olefin copolymer (COC).

The touch apparatus 100 of FIG. 1 shows only primary components of the first embodiment. A person skilled in the pertinent art may add or insert, when necessary, additional components, for example, between the first electrode layer 12 and the OCA layer 13, or between the second electrode layer 14 and the adhesive layer 15.

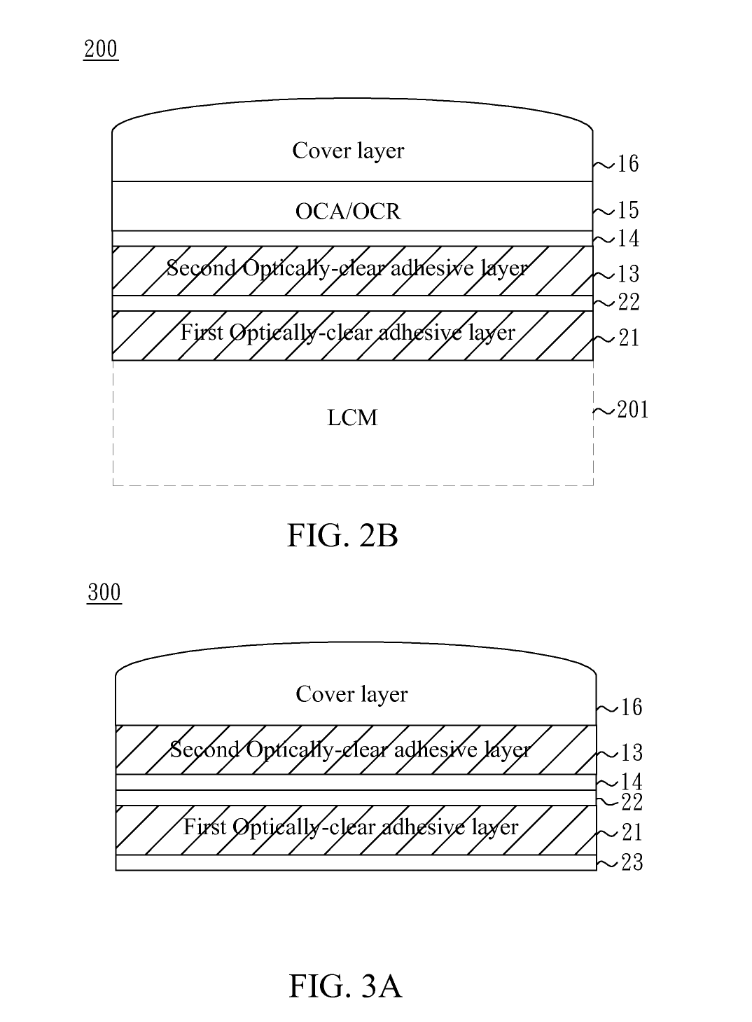

FIG. 2A shows a cross-sectional view of a touch apparatus 200 according to a second embodiment of the present invention. Components the same as the first embodiment are denoted with the same numerals, and their descriptions are omitted for brevity. As shown in FIG. 2A, a first optically-clear adhesive (OCA) layer 21 and a first electrode layer 22 replace the transparent substrate 11 and the first electrode layer 12 of the first embodiment (FIG. 1). In the embodiment, the first OCA layer 21 and the first electrode layer 22 compose a transparent conductive transfer film (TCTF). The first electrode layer 22 of the embodiment may have a thickness greater than 50 micrometers. The first electrode layer 22 may comprise non-transparent conductive material such as metal nanowires (e.g., silver nanowires or copper nanowires) or metal nanonets (e.g., silver nanonets or copper nanonets).

According to one aspect of the embodiment, in addition to the (second) OCA layer 13 acting as a substrate for the second electrode layer 14 to replace the conventional transparent substrate and the adhesive, the embodiment further utilizes the first OCA layer 21 acting as a substrate for the first electrode layer 22 to replace the conventional transparent substrate (e.g., the transparent substrate 11 in FIG. 1). Accordingly, the overall thickness of the touch apparatus 200 of the present embodiment may be less than that of the touch apparatus 100 of the first embodiment (FIG. 1). Moreover, as the electrode layers 22 and 14 are adhesively bonded with the OCA layers 21 and 13, respectively, the manufacturing of the touch apparatus 200 may be adapted to a low-temperature process.

On a bottom surface of the first OCA layer 21 of the embodiment may be included a release layer 23. When the release layer 23 is peeled off, the touch apparatus 200 may be bonded with another device, such as a liquid crystal module (LCM) 201, to result in a touch screen as illustrated in FIG. 2B.

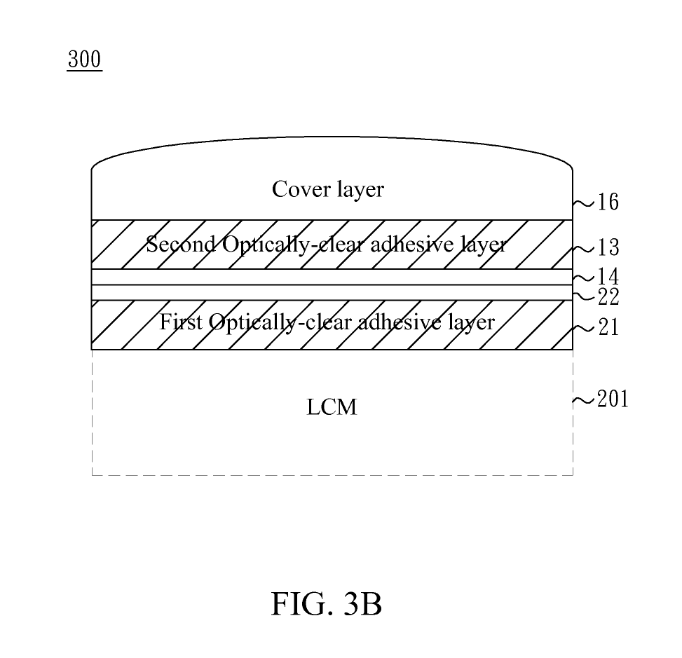

FIG. 3A shows a cross-sectional view of a touch apparatus 300 according to a third embodiment of the present invention. Like components (as the first embodiment) are denoted with like numerals, and their descriptions are omitted for brevity. As shown in FIG. 3A, the second electrode layer 14 of the embodiment is directly bonded with a top surface of the first electrode layer 22, and the second OCA layer 13 is directly adhered to a cover layer 16, thereby enabling omission of the adhesive layer 15 used in FIG. 2A. Accordingly, the overall thickness of the touch apparatus 300 of the present embodiment may be less than that of the touch apparatus 200 of the first embodiment (FIG. 2A).

On a bottom surface of the first OCA layer 21 of the embodiment may be included a release layer 23. When the release layer 23 is peeled off, the touch apparatus 300 may be bonded with another device, such as a liquid crystal module (LCM) 201, thereby to result in a touch screen as illustrated in FIG. 3B.

Although specific embodiments have been illustrated and described, it will be appreciated by those skilled in the art that various modifications may be made without departing from the scope of the present invention, which is intended to be limited solely by the appended claims.

What is claimed is:

1. A touch apparatus, comprising:
at least one optically-clear adhesive (OCA) layer;
a first electrode layer; and
a second electrode layer bonded with one of the at least one OCA layer, the OCA layer bonded with the second electrode layer acting as a substrate and an adhesive.

2. The touch apparatus of claim 1, further comprising a transparent substrate, the first electrode layer being formed on a top surface of the transparent substrate, and the OCA layer bonded with the second electrode layer being formed above the first electrode layer.

3. The touch apparatus of claim 2, further comprising a cover layer adhered to the second electrode layer.

4. The touch apparatus of claim 2, wherein the first electrode layer comprises transparent conductive material, and the second electrode layer comprises non-transparent conductive material.

5. The touch apparatus of claim 4, wherein the non-transparent conductive material comprises metal nanowires or metal nanonets.

6. The touch apparatus of claim 1, wherein the first electrode layer is bonded with another of the at least one OCA layer, and the OCA layer bonded with the second electrode layer is disposed above the first electrode layer.

7. The touch apparatus of claim 6, further comprising a cover layer adhered to the second electrode layer.

8. The touch apparatus of claim 6, wherein the first electrode layer and the second electrode layer comprise non-transparent conductive material.

9. The touch apparatus of claim 8, wherein the non-transparent conductive material comprises metal nanowires or metal nanonets.

10. The touch apparatus of claim 1, wherein the first electrode layer is bonded with another of the at least one OCA layer, and the second electrode layer is bonded with a surface of the first electrode layer.

11. The touch apparatus of claim 10, further comprising a cover layer that is adhered to the OCA layer bonded with the second electrode layer.

12. The touch apparatus of claim 10, wherein the first electrode layer and the second electrode layer comprise non-transparent conductive material.

13. The touch apparatus of claim 12, wherein the non-transparent conductive material comprises metal nanowires or metal nanonets.
